(19) United States
(12) Patent Application Publication
(10) Pub. No.: US 2026/0220005 A1
(43) Pub. Date: Jul. 30, 2026

(54) Node Fencing In Storage Clusters

(71) Applicant: NetApp, Inc., San Jose, CA (US)

(72) Inventors: Reyaz Ahmed, Fremont, CA (US); Todd Jason Mills, Union City, CA (US); Aleksandr Sergeev Khasymski, San Jose, CA (US); Rahul Thekkalore Srinivasa, Livermore, CA (US)

(21) Appl. No.: 19/036,914

(22) Filed: Jan. 24, 2025

(51) Int. Cl. G06F 11/20; G06F 11/16

(52) U.S. Cl. CPC G06F 11/2025; G06F 11/1666

(57) ABSTRACT

Techniques and systems for enhanced storage system management and failure detection/mitigation are presented. In one example, a method includes, responsive to detection of a trigger event for a first host node monitored by at least a second host node, initiating fencing of the first host node by at least transferring a fencing notification to a controller module for a set of storage drives assigned to the first host node. The method also includes preventing the first host node from communicating with the set of storage drives, and alerting a client node communicating with the first host node that the second host node is handling communication with the set of storage drives.

### BACKGROUND

Enterprise class storage systems can include large quantities of storage drives which are included in modular rackmount systems. These storage drives can be coupled in various architectures to storage controller nodes and to host nodes that serve data to/from client devices. The various elements can be coupled over a communication network or communication fabric. Many older storage architectures include use of fixed-configuration servers (e.g., blade servers) that can access storage drives over network links in generally static arrangements.

Modern storage architectures can employ disaggregated arrangements. In these disaggregated arrangements, a relationship between host nodes and storage modules that include storage drives can be more flexible and dynamic. For example, any host node might be dynamically coupled to a set or storage drives to suit present workloads with an ad hoc communication fabric configuration scheme. Moreover, redundancy for storage drives and host devices can be established across these communication fabrics to form large, disaggregated storage clusters with high availability and high reliability.

In disaggregated storage clusters, ensuring high availability and data integrity is desired. These clusters can include multiple host nodes working together to provide redundant and reliable data access and storage services to client devices. However, when a host node begins to fail or experiences performance degradation, such a host node can jeopardize storage system stability and data integrity. A failing host node may become unable to serve data to clients effectively, leading to potential data loss, corruption, delays, contention, or significant performance bottlenecks.

### SUMMARY

Techniques and systems for enhanced storage system management and failure detection/mitigation are presented. Example implementations include node fencing as a failure mitigation mode. Node fencing, as discussed herein, includes various architectures, operations, and control schemes that establish isolation of a node from performing various operations (such as storage input/output operations) within a cluster of computing nodes. This fencing can include protection of shared resources when a node appears to be malfunctioning. While the fencing discussions herein employ disaggregated storage networks, it should be understood that these examples can instead apply to other types and architectures of storage systems.

In one example implementation, a method includes, responsive to detection of a trigger event for a first host node monitored by at least a second host node, initiating fencing of the first host node by at least transferring a fencing notification to a controller module for a set of storage drives assigned to the first host node. The method also includes preventing the first host node from communicating with the set of storage drives, and alerting a client node communicating with the first host node that the second host node is handling communication with the set of storage drives.

In another example implementation, an apparatus is provided that includes one or more computer readable storage media and program instructions stored on the one or more computer readable storage media. Based on being executed by a processing system, the program instructions direct the processing system to at least initiate fencing of a first host node by at least detection of a trigger event for the first host node monitored by at least a second host node and transferring a fencing notification to a controller module for a set of storage drives assigned to the first host node. Responsive to the fencing notification, the program instructions further direct the processing system to prevent the first host node from communicating with the set of storage drives, and alert a client node communicating with the first host node that the second host node is handling communication with the set of storage drives, wherein subsequent to the trigger event, the second host node handles further storage transactions with respect to the client node.

In yet another example implementation, a system includes a first host node, a second host node, and a storage input/output module coupled over a communication fabric. The system includes the first host node configured to handle storage transactions for a client node with respect to an assigned set of storage drives managed by the storage input/output module. The system also includes the second host node configured to monitor the first host node for a failure event. Responsive to detection of the failure event for the first host node, the second node is configured to initiate fencing of the first host node by at least transferring a fencing notification to the storage input/output module. The storage input/output module is configured to prevent the first host node from communicating with the set of storage drives. The second host node is configured to alert the client node that the second host node is handling subsequent storage transactions with the set of storage drives.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an example network storage environment in an implementation.

FIG. 2 illustrates example operations of a storage system in an implementation.

FIG. 3 illustrates an example disaggregated storage environment in an implementation.

FIG. 4 illustrates an example disaggregated storage environment in an implementation.

FIG. 5 illustrates an example fencing control system for a storage environment in an implementation.

### DETAILED DESCRIPTION

Techniques and systems for enhanced clustered and disaggregated storage system management and host node failure detection/mitigation are presented. Example implementations include host node fencing as a failure mitigation mode. Node fencing, as discussed herein, includes various architectures, operations, and control schemes that establish isolation of a node from performing various operations (such as storage input/output operations) within a cluster of computing nodes. This fencing can include protection of shared resources when a node appears to be malfunctioning.

As the number of computing (or host) nodes in a cluster increases, the probability of node failure also rises. When a node fails or begins to fail, such a node may still retain access to shared storage resources provisioned through an input/output module (IOM) within a switched communication fabric. To protect data integrity as well as ensure continued functionality of remaining elements of a computing or storage cluster, the examples herein advantageously isolate a failing node and reclaim resources presently assigned to a failing node. In the examples herein, this is referred to as fencing or node fencing, and this fencing can be employed to prevent a failed node from performing active I/O transactions to a shared storage pool, terminate any transient activities, and ultimately disallow access for the failed node to the shared storage pool, thereby ensuring data integrity, among other enhancements.

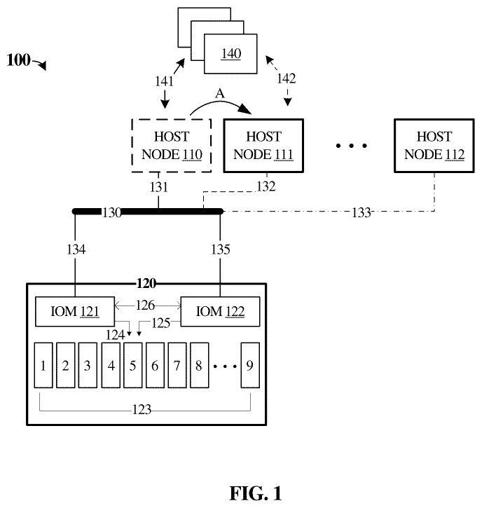

Turning now to a first example implementation, FIG. 1 is provided. FIG. 1 includes system 100 having a computing and storage cluster in one example configuration. This computing and storage cluster can be an example of a disaggregated computing or storage environment, fabric-coupled storage system, or other types of systems. Typically, a cluster management node (not shown) can arrange various computing, storage, network, processing, and interfacing elements into arbitrary and dynamic collections that are communicatively coupled over a switched communication fabric. This fabric might be configured to provide logical isolation in the communication fabric among the elements within a collection, and this logical isolation can be changed on-the-fly to suit computing needs during operation. For example, a selected quantity of storage drives might be configured to be assigned to a selected quantity of host nodes.

Thus, the example in FIG. 1 shows one such example collection of elements which includes a host node comprising a processing element, a storage module having one or more storage drives, and a storage controller or input/output module (IOM), referred to as an IOM herein. More than one IOM can be included for redundancy and assigned to handle or manage the same set of storage drives. Also, more than one host node can be included in the collection of elements to provide for redundancy and monitoring of peer nodes. Various network or fabric interfacing elements can also be included, such as fabric communication interfaces and client communication interfaces.

Turning now to the elements of FIG. 1, system 100 includes host nodes 110-112, storage ‘shelf’ 120, and client nodes 140. Storage shelf 120 includes IOMs 121-122, and storage drives 123. A different quantity of storage shelves and storage drives can be included in storage shelf 120, although nine (9) storage drives and one (1) storage shelf are shown in FIG. 1 as an example. In addition, host nodes 110-112 and storage shelf 120 communicate over associated communication links 131-135 which can be coupled through a switchable communication fabric 130, although variations are possible. Client nodes 140 can communicate over links 141-142 with one or more host nodes. IOMs 121-122 can redundantly communicate with any among storage drives 123 over links 124-125. IOMs 121-122 can communicate with each other over link 126, which may comprise a sideband communication link or channel.

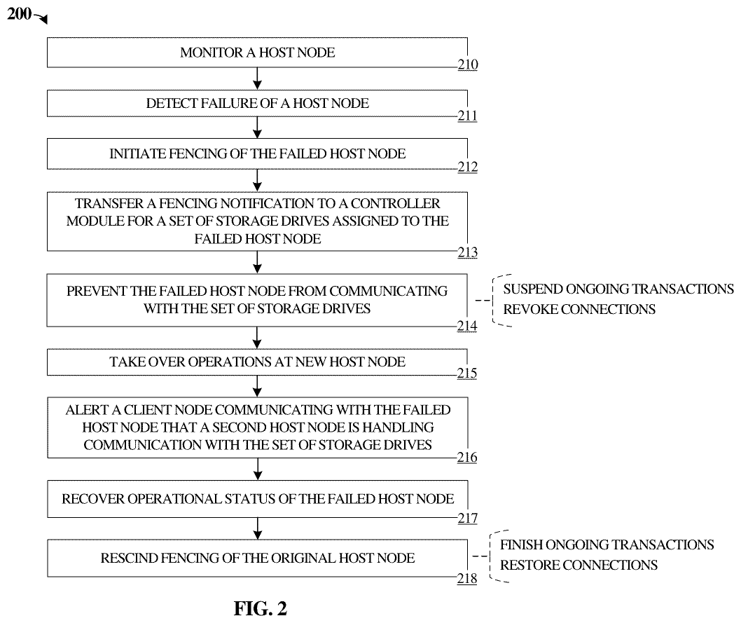

Example operations for elements of FIG. 1 are now discussed in operations 200 of FIG. 2. Operation 200 can include example operations for elements of system 100, but these operations can also be applied to other elements discussed herein. Also, a subset of operations 200 or a different ordering might be employed in other examples.

In operation 210, a host node monitors another host node in a peer monitoring arrangement, although other monitoring configurations are possible including self-monitoring. In FIG. 1, host node 110 can be monitored by one or more other host nodes among host nodes 111-112. For example, host node 111 can monitor host node 110 for operational status, failure modes, and other failure or reduced functionality indications. In one example, host node 110 provides a heartbeat to host node 111, which can include periodic transmission of data packets or other datagrams indicating a working condition of host node 110. Other monitoring is possible, such as monitoring provided by watchdog circuitry within any among host node 110 or 111.

Based on this monitoring, host node 111 can detect failure of host node 110 in operation 211. The failure can include various failure modes, including failure or degradation of processors, network interfaces, software components, hardware components, circuit board components, power supplies, cabling, data center infrastructure, or other elements. Thus, host node 111 might be optionally located remotely with respect to host node 110 to provide off-site redundancy. When host node 111 detects failure of host node 110, host node 111 can initiate fencing of host node 110.

In operation 212, fencing includes isolation of host node 110, notification of various nodes or other devices of the state of the fencing initiation, and failover of the functionality of host node 110 to another host node (e.g., host node 111). First, host node 111 detects the failure of host node 110, as noted above in operations 210 and 211. Then, in operation 213, host node 111 can transfer a fencing notification to a controller module for a set of storage drives assigned to the failed host node 110. In this example, the controller module includes IOM 121 in storage shelf 120. IOM 121 can be included within shelf 120 to control operations of various storage drives of the shelf, such as by handling transfer of storage operations to/from individual storage drives 123. The assigned set of storage drives can include one or more among storage drives 123, and originally can be assigned to host node 110 for handling of storage transactions, storage operations, storage I/O, and other traffic with respect to one or more client nodes 140 over link(s) 141.

In operation 214, IOM 121 can responsively prevent failed host node 110 from communicating with the assigned set of storage drives. This can include suspending ongoing transactions with respect to the storage drives received from host node 110, and revoking of connections between the storage drives (or IOM 121) and host node 110. Suspension of ongoing transactions includes refusing new transactions transferred by host node 110 and allowing existing transactions to complete or synchronize with respect to the storage drives. In this manner, in-transit storage transactions can be completed, but new or additional transactions can be halted to protect data integrity and prevent data corruption or data out-of-synchronization conditions. Revocation of connections can include tearing-down of logical or physical connections between shelf 120 and host node 110, including removal of host node 110 from partitioning within a communication fabric, revocation of existing remote direct memory access (RDMA) connections associated with host node 110, removal of fabric connections or network ports corresponding to host node 110, or other connection changes.

These suspension and revocation operations can be performed by various elements of system 100, such as host node 111, IOM 121, fabric switch elements, or other components, including combinations thereof, which are triggered by the initiation of the fencing arrangement by host node 111.

Operation 215 includes at least one host node taking over operations or roles performed by host node 110, such as host node 111 in FIG. 1. Host node 111 can initiate one or more storage handling applications, fabric connections, network connections, and other activities to establish a storage host for one or more clients. This can include taking over an identity or various storage targets originally associated with or assigned to host node 110. In some examples, this includes changing identities or target properties, such as discussed in operation 216.

Operation 216 includes host node 111 informing any client devices communicating with host node 110 to change a communication pathway or communication link properties to reach the same set of storage drives. This can include transfer of a network addressing change message to client node 140 by host node 111, which can indicate a new network address, port, socket, storage target, or other link parameter to reach the storage drives through host node 111 instead of through host node 110. For example, host node 111 can transfer a message to client device 140 that network link 141 having different network addressing than link 140 can be employed to reach the corresponding storage drives.

From here, host node 111 can operate normally for storage operations and transactions with regard to client node 140 and storage shelf 120. However, during these operations, the failure or degradation of host node 110 might be repaired or fixed. This can include attempting to recover a desired operational status of the failed host node, as indicated in operation 217. Example recovery operations include reboot, power cycling, operating system reinstall, software version roll-back, software restart, application container reinitialization, virtual machine recovery/restart, or other various hardware and software recovery operations. If host node 110 fails to recover, then such node can be indicated as an unrecoverable failure, which may require hardware replacement and/or physical swapping of components associated with host node 110.

However, if host node 110 does recover a desired level of operational status, then host node 110 can resume prior operations and relinquish host node 111 to perform other tasks. This can include, in operation 218, rescinding of the fencing of host node 110 initiated by host node 111 and restoration of connections associated with host node 110, including network connections, fabric connections, RDMA connections, and the like. Notification of client nodes also can be performed by now-recovered host node 110, among other operations.

Returning to the elements that are found in system 100, client nodes 140 can each comprise various endpoint devices or intermediate nodes configured to interface with one or more storage drives of system 100. Client nodes 140 can provide applications and other software environments for access to data storage units provided by storage drives 123, which can include operating systems, containerized software elements, user-level applications, client/server arrangements, data hosting operations, data server or data transfer nodes, and other various types of data or storage servicing elements. In some examples, client nodes 140 comprise processing circuitry, local storage devices, network interface elements, user interface elements, and other components that form various computing devices, servers, blade server modules, laptop computing devices, gaming devices, tablet computing devices, smartphone devices, data relay devices, virtualized servers, virtual machines, containerized systems, or other endpoint computing device, interworking node, or intermediary computing device.

Host nodes 110-112 can each include processing circuitry, such as one or more microprocessors, central processing units (CPUs), graphics processing units (GPUs), discrete logic, programmable logic devices, and other support circuitry and devices, such as memory devices, network interfacing elements, communication fabric interfacing elements, and user interface elements, among other elements. Host nodes 110-112 can be implemented as a single processing device, but instead may be distributed across more than one processing device or system that cooperate in executing program instructions. Host nodes 110-112 also can include various executable software configured to perform operations described herein, such as to provide node fencing, isolation, monitoring, recovery, and other storage system operations. In some examples, host nodes 110-112 components that form various computing devices, servers, blade server modules, laptop computing devices, gaming devices, tablet computing devices, smartphone devices, data relay devices, virtualized servers, virtual machines, containerized systems, or other endpoint computing device, interworking node, or intermediary computing device.

Communication fabric 130 includes fabric ports which can couple to various nodes over associated fabric links 131-135, typically comprising point-to-point serial links. Communication fabric 130 can include various networks, communication fabrics, crosspoint switches, packet switching elements, controllers, distribution hubs, or other intermediary elements. In some examples, fabric ports and links include switched network connections compatible with Ethernet standards corresponding to wired or wireless connections, which can refer to any of the various network communication protocol standards and bandwidths available, such as 10BASE-T, 100BASE-TX, 1000BASE-T, 10GBASE-T (10 GB Ethernet), 40GBASE-T (40 GB Ethernet), gigabit (GbE), terabit (TbE), 200 GbE, 400 GbE, 800 GbE, or other various wired and wireless formats and speeds.

In other examples, communication fabric 130 can comprise connections, ports, or links that conform to various protocols and standards including FibreChannel, Peripheral Component Interconnect Express (PCIe), Compute Express Link (CXL), Gen-Z, InfiniBand, NVMe, NVM Express over Fabrics (NVMe-oF), NVLink, Cache Coherent Interconnect for Accelerators (CCIX), Compute Express Link (CXL), and Open Coherent Accelerator Processor Interface (OpenCAPI), among others. When PCIe is employed, various versions or generations can be used, such as PCIe generations 3.0, 4.0, 5.0, 6.0, Gen-Z, and beyond. When NVMe-oF is employed, NVMe-oF can comprise a network protocol which provides remote direct memory access (RDMA) over Ethernet networks instead of over directly-coupled PCIe links or PCIe fabrics.

Any of the links in FIG. 1 can each use various communication media, such as air, space, metal, optical fiber, or some other signal propagation path, including combinations thereof. Any of the links in FIG. 1 can include any number of nested links or lane configurations. Any of the links in FIG. 1 can each be a direct link or might include various equipment, intermediate components, systems, and networks. Any of the links in FIG. 1 can each be a common link, shared link, aggregated link, or may be comprised of discrete, separate links.

Storage shelf 120 comprises a chassis, sled, enclosure, housing, or other assembly element that can house circuitry of IOMs 121-122 and storage drives 123, among other elements, such as power supplies, monitoring circuitry, interfacing circuitry, fans, cooling elements, and other various components. Storage shelf 120 can be configured to removably couple to storage drives 123 for removal and insertion of modular data storage units. Storage shelf 120 can be further removably coupled into a storage or computing system, such as a midplane, backplane, rack, chassis, or other larger assembly which may include other iterations of storage shelf 120 and associated storage drives.

IOMs 121-122 can each include processing circuitry, such as one or more microprocessors, central processing units (CPUs), application specific integrated circuits (ASICs), discrete logic, programmable logic devices, and other support circuitry and devices, such as memory devices, network interfacing elements, and communication fabric interfacing elements, among other elements. IOMs 121-122 can be implemented as a single processing device, but instead may be distributed across more than one processing device or system that cooperate in executing program instructions. IOMs 121-122 also can include various executable software configured to perform operations described herein, such as to provide storage operations for storage shelf 120, manage various storage drives, and interface with host nodes to establish node fencing, node isolation, monitoring, recovery, and other storage system operations.

IOMs 121-122 can comprise storage controllers which can receive storage transactions, such as read transactions and write transactions over fabric links, as transferred by host nodes. Responsive to a read transaction, IOMs 121-122 can interface with one or more storage drives to read data from corresponding storage media as identified by the read transaction, and transfer the data for delivery to an associated host node that originated the storage transaction. Responsive to a write transaction, IOMs 121-122 can interface with one or more storage drives to write data that accompanies the write transaction to storage media. IOMs 121-122 can implement various storage control schemes, such as wear leveling, striping, mirroring, error checking and correction, encryption/decryption, deduplication, partitioning, virtual volume handling, and other techniques. IOMs 121-122 also can include various executable software and associated hardware configured to provide dual-port functionality for single-port storage drives.

IOMs 121-122 can also include sideband links for direct, non-fabric, communication. These sideband links can be employed for various protocol or link identification signaling, handshaking signaling, initialization signaling, manufacturing testing signaling, debug signaling, failover or redundancy signaling, or other signaling. Example protocols and signaling for the sideband link includes any of the link types discussed herein, or may include System Management Bus (SMBus), Joint Test Action Group (JTAG), Inter-Integrated Circuit (I2C), controller area network bus (CAN), Universal Serial Bus (USB), or other various discrete signaling.

Storage drives 123 each comprise storage connectors, storage media, and data storage and handling circuitry. In some examples, each storage drive 123 comprises a single-port device, referring to being able to natively communicate with only a single host. However, some examples might include one or more of storage drives 123 as dual-port devices operated in a single-port mode. Storage connector can comprise a U.2 connector (SFF-8639), U.3 connector, M.2 connector (NGFF), M.3 connector, or Enterprise and Data Center Standard Form Factor (EDSFF) connector, MCIO connector, Next Generation Small Form Factor (NGSFF/NF1), among others. Storage media can comprise solid state storage media, such as flash memory, static RAM, NAND flash memory, NOR flash memory, memristors, or other solid state media. In other examples, each storage media can comprise magnetic storage, such as hard disk drive rotating media, magnetoresistive memory devices, and the like, or can comprise optical storage elements, such as phase change data storage.

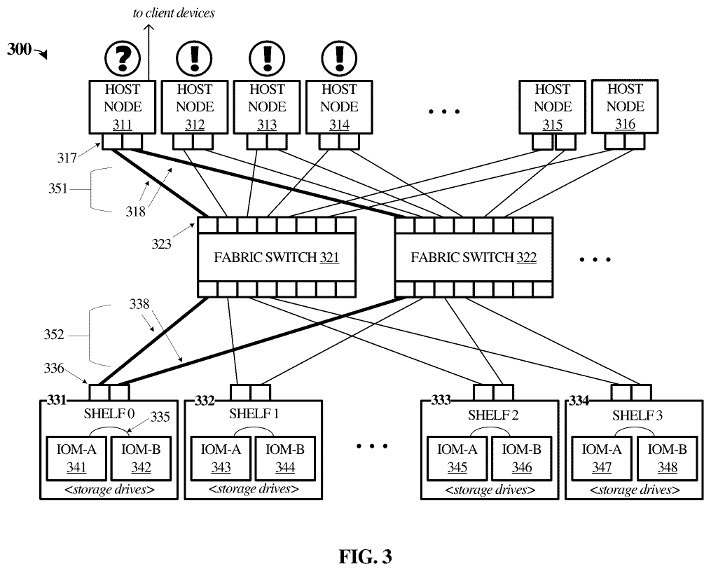

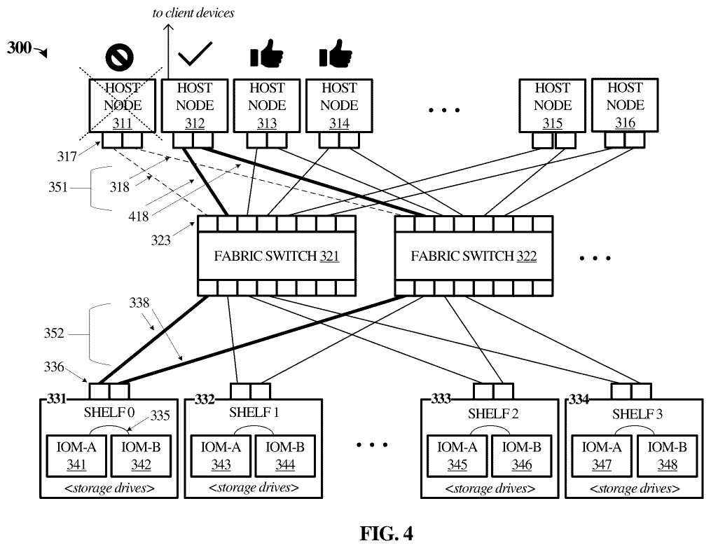

FIGS. 3 and 4 are now presented showing system 300 and other example implementations of host node fencing. FIG. 3 illustrates a first set of operations for system 300 for monitoring host nodes, while FIG. 4 illustrates a second set of operations for system 300 having a node fencing arrangement.

System 300 includes host nodes 311-316 each having various network connections 317, which comprise dual or redundant connections for each host node in this example.

System 300 also includes fabric switches 321-322 and fabric links 351-352, which can comprise various types of communication fabric switch equipment configured to selectively couple connections 323 and associated fabric links 351-352 into various configurable groups or arrangements. Various storage shelves 331-334 are included, each having an associated set of storage drives and storage controller modules, referred to as IOMs, and including IOMs 341-348. Although storage drives and client nodes are omitted from FIGS. 3 and 4 for clarity, it should be understood that various quantities of such elements can be included and coupled over appropriate communication links.

In some examples, system 300 can form at least a portion of a disaggregated storage network where a multitude of compute nodes, namely host nodes 311-316, can concurrently access storage media over a switched fabric coupling a multitude of storage enclosures composed of redundant IOMs and housing multiple storage drives. In this disaggregated architecture, various separate collections or sets of storage drives can be formed by configuring fabric connections and port partitioning to include these storage drives along with associated host nodes and other desired components. In storage system scenarios, this disaggregated architecture provides for many concurrent storage hosts that can serve many concurrent client devices, primarily for the storage and retrieval of data.

For example, a storage arrangement can be formed in system 300 which includes host node 311 and shelf 0 331, along with various communication links over a communication fabric provided by fabric switches. One example set of links includes host-side links 318 and shelf-side links 338, and these links form dual-redundant fabric links with fabric switches 321-322. Other host nodes can have corresponding fabric links which may be employed during monitoring operations or remain largely dormant until take-over of a failing node is desired.

In addition to host node 311, one or more redundant, fail-over, or actively monitoring host nodes can be included in this storage arrangement, such as host nodes 312-314. These additional host nodes can be included for load balancing, striping, parallelism, or other functions, along with their primary function of monitoring and redundancy for host node 311. In operation, host node 311 can receive storage transactions over a client link with a client node (not shown), and handle storage and retrieval of associated data on affected storage drives included in storage shelves. In this manner, host node 311 can provide a storage service to client nodes, which might correspond to a cloud storage service, distributed storage service, storage area network, or other various designations. Host node 311 can provide various logical arrangements for such storage services, such as volumes, logical drives, folders, shared storage spaces, and the like.

In FIG. 3, host node 311 might enter a failure mode, such as a hardware, software, or communication failure which prevents or degrades host node 311 with regard to servicing client nodes. One or more monitoring host nodes, namely host nodes 312-314 can be configured to monitor for operational status of host node 311 and detect fencing trigger events, such as a failure of host node 311. This monitoring can include various periodic health checks, periodic heartbeat signaling, telemetry monitoring, or other operational monitoring indicating host node 311 is unresponsive. Once one of host nodes 312-314 detects that host node 311 has entered a failure mode, this detection can comprise a trigger event initiating fencing and takeover of the services provided by host node 311, advantageously reducing down time for client nodes and seamlessly providing service continuity despite failures of host node 311.

The example shown in FIG. 3 includes multiple host nodes configured to monitor operation of host node 311, and each monitoring node might attempt to take over operation for failing host node 311 and initiate a fencing operation to claim storage resources of host node 311 in order to continue serving I/Os to any client nodes. In such scenarios, one node within the storage cluster is selected amongst the monitoring nodes (host nodes 312-314), and can then take over the responsibilities of the failing host node 311 to maintain service continuity. However, this takeover process can lead to contention among host nodes 312-314 vying for ownership, resource conflicts, and further instability if not managed correctly. Thus, FIGS. 3 and 4 include example operations to efficiently segregate, isolate, and fence failing host node 311 to prevent it from affecting the overall cluster performance to ensure a smooth and conflict-free transition of failing host node 311 service responsibilities to new host node, while multiple nodes compete for ownership.

Responsive to detection of a trigger event for host node 311 monitored by at least a second host node (host nodes 312-314), the monitoring host nodes can initiate fencing of the host node 311 by at least transferring a fencing notification to a controller module for a set of storage drives assigned to host node 311. In this example, the controller module comprises an IOM for a storage shelf that includes the affected storage drives, namely IOM-A 341 in storage shelf 331. A trigger event, as noted above, can correspond to one or more conditions being satisfied with regard to operational status of host node 311 as monitored by host nodes 312-314. Fencing requests or fencing notifications can then be initiated by host nodes 312-314, which indicate affected storage shelves and/or affected host nodes. A fencing operation then progresses, which includes preventing host node 311 from communicating with the set of storage drives of storage shelf 331.

Each host node can maintain a list of storage shelf identifiers (IDs) for storage shelves 331-334, such as in a data structure initialized by initialization processes or periodic update messaging, and also each host node can have a mechanism to target specific shelf IDs for node fencing requests. Within each shelf, there can be multiple IOMs, such as IOM-A 341 and IOM-B 342 of shelf 331, which are prioritized among for handling fencing requests. For instance, IOM-A 342 can be designated as the primary target for all fencing requests from host nodes within system 300. In one example, fencing requests can be transferred to an IOM on an active RDMA channel by associated host nodes trying to take ownership of the affected storage drives. If IOM-A is not responsive, or unreachable, over fabric links (e.g., 336), then sideband communication links (e.g., 335) can be employed to reach IOM-A through a redundant controller module, namely an IOM-B instance. This ensures that the fencing request is directed to IOM-A regardless of path availability.

When multiple host nodes, such as host nodes 312-314, attempt to initiate a fencing operation for a failing host node (e.g., 311), the multiple host nodes can indicate fencing requests to the primary IOM of an affected shelf using the shelf ID (e.g., shelf ID 0 for shelf 331). Host nodes 312-314 can all thus send fencing requests to IOM-A 341. Responsive to the multiple fencing requests, IOM-A 341 processes the fencing requests and selects one host node among the requesting nodes to take over responsibilities for the failing host node. IOM-A 341 can then send a response back to the ‘winning’ requesting host node, such as host node 312 in this example. Subsequent or pending fencing requests from other host nodes will complete successfully, acknowledging that the failing node has already been fenced. To verify which host node has successfully fences failing host node 311 and assumes its role, host nodes 312-314 can query shelf 331 by issuing a fence status command. The shelf (e.g., IOM-A) responds with a node ID of the winner of the fencing command.

Priority among host nodes 312-314 in acceptance or selection of their respective fencing requests can be determined by various prioritization schemes or arbitration factors. These include using factors such as a first node to initiate the fencing request messaging, a first fencing request to be received in IOM-A, a round-robin or rotating priority among host nodes, a proximity to the failing node (physically, logically, or topologically), a random selection, or other selection factors.

After a host node is selected during a fencing ‘race’ during which multiple fencing requests are received by a corresponding IOM, the selected (successful) host node (e.g., host node 312) can proceed to fence or isolate failing host node 311 from other shelves by sending fencing requests to the respective IOMs, ensuring complete isolation of failing host node 311 across the entire cluster. In a first operation for node fencing, host node 312 can ensure that failing host node 311 is not able to perform any storage I/O activities to affected storage media. As such, IOM-A 341 of shelf 331 is commanded by host node 312 to implement a series of actions to effectively isolate and fence the failing node. IOMs and remaining host nodes employ a protocol to guarantee that failing host node 311 is completely fenced from doing any read or write storage transactions to IOM-A 341 and a functional node (node 312) takes over ownership of assigned storage drives. In one example, the fencing request triggers the IOM to responsively suspend any ongoing I/O requests or storage transactions from failing host node 311. This prevents failing host node 311 from initiating new storage transactions or I/O with respect to affected storage drives. Additionally, the IOM allows in-flight transactions or I/O to be completed if they are in a state of safe completion, otherwise they get drained off a transaction queue to reduce risk to data integrity.

Next, connection revocation is performed for failing host node 311. For example, the IOM can revoke an existing fabric connection, such as an RDMA connection, from the failing host node 311 and ensure failing host node 311 cannot communicate with the IOM by blocking any future connection request from failing host node 311 over the fabric. The IOM can notify host node 312 and any other fencing request nodes about the status of the completion of the isolation process of failing host node 311. This ensures that host nodes in the cluster can better coordinate takeover of the responsibilities and roles of failing host node 311. Healthy host nodes within the cluster may choose to assist each other in coordinating resource reallocation and workload redistribution to maintain service continuity, among other operations.

As seen in FIG. 4, host node 311 has been isolated from the fabric and storage drives by having connections revoked for links 318. New links 418 are employed for host node 312 to communicate over the fabric with shelf 331 and links 318. Host nodes 313-314, which did not ‘win’ the fencing race for takeover of failing host node 311, remain active and can be used to monitor host node 312 for failure, attempt to assist in recovery of failing host node 311, or perform other activities with host node 312, such as load balancing or redundancy, and the like. Thus, in this fencing scenario shown in FIGS. 3 and 4, prior to a trigger event, host node 311 handles storage transactions with respect to client nodes, and subsequent to the trigger event and fencing operations, host node 312 handles further storage transactions with respect to the client nodes.

Host node 312 can notify client devices of a change in access parameters for access the assigned storage drives or data volumes previously handled by failing host node 311. For example, host node 312 can alert a client node initially communicating with host node 311 that host node 312 is handling communication with the set of storage drives. Host node 312 can also alert the client node by at least transferring a notification to the client node for network addressing used to reach the set of storage drives, where the network addressing corresponds to changing to a network address associated with host node 312 from a network address associated with host node 311. Host node 312 can then continue services previously provided by host node 311, such as handling storage transactions for client nodes with respect to the same set of storage drives in storage shelf 331.

Furthermore, while host node 311 is fenced, host node 311 can have various attempts made to recover normal operational status. Once the failing node is repaired or replaced, the healthy nodes can request the IOM to safely reintegrate it into the cluster, ensuring it can resume normal operations without risking data integrity. Example recovery operations include reboot, power cycling, operating system reinstall, software version roll-back, software restart, application container reinitialization, virtual machine recovery/restart, or other various hardware and software recovery operations. If host node 311 fails to recover, then such node can be indicated as an unrecoverable failure, which may require hardware replacement and/or physical swapping of components associated with host node 311. However, if host node 311 does recover a desired level of operational status, then host node 311 can resume prior operations and relinquish host node 312 to perform other tasks.

Recovery also can include host node 312 (or another designated recovery notification host node) transferring a fencing removal notification for the set of storage drives to the controller module, namely IOM-A 341 of shelf 331. IOM-A can perform a rescinding process for the fencing of host node 311, removal of the fencing status, notification of various nodes of such removal, and restoration of connections associated with host node 311, including network connections, fabric connections, RDMA connections, and the like. Notification of client nodes also can be performed by now-recovered host node 311, among other operations.

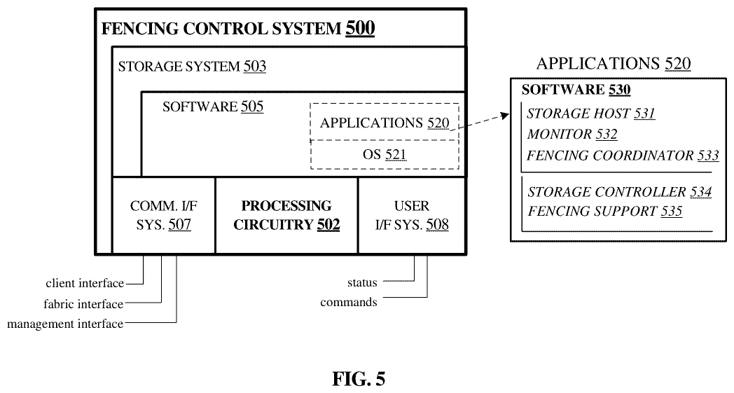

FIG. 5 illustrates an example fencing control system 500 for a storage cluster, system, or environment in an implementation. Fencing control system 500 includes processing circuitry 502, storage system 503, software 505, communication interface system 507, and user interface system 508. Fencing control system 500 illustrates an example of portions of any of the host nodes, IOMs, storage controllers, fabric control elements, fencing control elements, or other elements discussed herein, such as portions of host nodes 110-112 or IOMs 121-122 in FIG. 1, or host nodes 311-316, fabric switches 321-322, or IOMs 341-348 in FIGS. 3 and 4.

Fencing control system 500 can represent a computing system with which at least software 505 is deployed and executed in order to render or otherwise implement the operations described herein. However, fencing control system 500 can also represent any computing system on which at least software 505 and associated data can be staged and from where software 505 and data can be distributed, transported, downloaded, or otherwise provided to another computing system for deployment and execution, or for additional distribution.

Processing circuitry 502 can be implemented within a single processing device but can also be distributed across multiple processing devices or sub-systems that cooperate in executing program instructions. Examples of processing circuitry 502 include general purpose central processing units, microprocessors, application specific processors, and logic devices, as well as any other type of processing device. In some examples, processing circuitry 502 includes physically distributed processing devices, such as cloud computing systems.

Communication interface system 507 includes one or more communication and network interfaces for communicating over communication fabrics, communication links, or communication networks, such as packet networks, the Internet, and the like. The communication interfaces can include one or more Ethernet interfaces or sideband links, or one or more network or fabric communication interfaces which can communicate over Ethernet, Internet protocol (IP), or any of the various communication links discussed herein. Communication interface system 507 can include network interfaces configured to communicate using one or more network addresses, which can be associated with different network links. Examples of communication interface system 507 include network interface card equipment, transceivers, modems, and other communication circuitry.

Storage system 503 can comprise a non-transitory data storage system, although variations are possible. Storage system 503 can comprise any storage media readable by processing circuitry 502 and capable of storing software. Storage system 503 can include volatile and nonvolatile media, removable and non-removable media, implemented in any method or technology for storage of information, such as computer readable instructions, data structures, program modules, or other data. Storage system 503 can include non-volatile storage media, such as solid-state storage media, flash memory, phase change memory, or magnetic memory, including combinations thereof. Storage system 503 can be implemented as a single storage device but can also be implemented across multiple storage devices or sub-systems. Storage system 503 can comprise additional elements, such as controllers, capable of communicating with processing circuitry 502.

Software stored by storage system 503 can comprise computer program instructions, firmware, or some other form of machine-readable processing instructions having processes that when executed a processing system direct fencing control system 500 to operate as described herein. The software can also include user software applications, application programming interfaces (APIs), or user interfaces. The software can be implemented as a single application or as multiple applications. In general, the software can, when loaded into a processing system and executed, transform the processing system from a general-purpose device into a special-purpose device customized as described herein.

Software 505 includes applications 520 and operating system (OS) 522. Software elements 530 each comprise executable instructions which can be executed by processing circuitry 502 for operating according to the operations discussed herein. For example, when implementing at least a portion of a host node, software 505 can drive processing circuitry 502 to receive storage transactions transferred by multiple clients and transfer the storage transactions for handling by a storage controller in a storage shelf containing storage drives, monitor other host nodes for operational status, responsive to trigger events initiate fencing operations, perform fencing operations, and perform node recover operations, among other operations. When implementing portions of an IOM or storage controller, software 505 can drive processing circuitry 502 to handle storage operations with respect to a set of assigned storage drives, manage such storage drives, and perform various fencing operations with respect to host nodes, as discussed herein, among other operations.

In FIG. 5, examples of software elements 530 include one or more among storage host 531, monitor 532, fencing coordinator 533, storage controller 534, and fencing support 535. Storage hosts, such as host nodes, typically comprise software elements including storage host 531, monitor 532, and fencing coordinator 533. Storage controllers, such as IOMs, typically comprise software elements including storage controller 534 and fencing support 535.

Storage host 531 communicates with client nodes/devices over various communication links, such as to receive storage transactions and deliver requested data within a storage cluster. Storage host 531 can also establish various logical arrangements of storage resources, assign network-or fabric-routable addressing to such resources, and perform various storage cluster management functions. Monitor 532 can monitor other instances of storage hosts, which may reside in the same or different hardware than storage host 531. Fencing coordinator 533 can initiate fencing of a storage host by at least detection of a trigger event for the storage host, and transfer a fencing notification to a controller module for a set of storage drives assigned to the storage host. Fencing coordinator 533 can also alert a client node communicating with the first host node that the second host node is handling communication with the set of storage drives. Fencing coordinator 533 can also perform various operations to unwind a fencing configuration responsive to a failed node or host resuming operational status.

Storage control 534 communicates with storage drives of a storage shelf to manage such storage drives, distribute storage transactions to the storage drives, and deliver requested data to a storge host. Fencing support 535 can receive fencing notifications and responsively perform various fencing activities, including selecting a storage host among various storage hosts to act in place of a failing storage host, remove connections to a failing storge host, and isolate a failing storage host from assigned storage drives, among other activities.

User interface system 508 can be optionally employed to accept commands to manage, select, and alter operational configurations of a storage cluster or system, as well as provide operational status, telemetry, and updates for various elements of a storage cluster or system. User interface system 508 can comprise software-based interfaces or hardware-based interfaces. Hardware-based interfaces include touchscreen, keyboard, mouse, voice input device, audio input device, or other touch input device for receiving input from a user. Output devices such as a display, speakers, web interfaces, terminal interfaces, and other types of output devices may also be included in user interface system 508. User interface system 508 can provide output and receive input over a network interface, such as communication interface system 507. In network examples, user interface system 508 might packetize display or graphics data for remote display by a display system or computing system coupled over one or more network interfaces. Physical or logical elements of user interface system 508 can provide alerts or visual outputs to users or other operators. User interface system 508 may also include associated user interface software executable by processing circuitry 502 in support of the various user input and output devices discussed above. Separately or in conjunction with each other and other hardware and software elements, the user interface software and user interface devices may support a graphical user interface, a natural user interface, or any other type of user interface. User interface system 508 can present command line interfaces (CLIs), application programming interfaces (APIs), graphical user interfaces (GUIs), representational state transfer (REST) interfaces, RestAPIs, WebSocket interfaces, or other interfaces to one or more users.

The functional block diagrams, operational scenarios and sequences, and flow diagrams provided in the Figures are representative of exemplary systems, environments, and methodologies for performing novel aspects of the disclosure. The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the disclosed examples. Those skilled in the art will also appreciate that the features described above can be combined in various ways to form multiple implementations. As a result, the invention is not limited to the specific implementations described above, but only by the claims and their equivalents. Thus, the descriptions and figures included herein depict specific implementations to teach those skilled in the art how to make and use the best options. For the purpose of teaching inventive principles, some conventional aspects have been simplified or omitted. Those skilled in the art will appreciate variations from these implementations that fall within the scope of this disclosure. Those skilled in the art will also appreciate that the features described above can be combined in various ways to form multiple implementations.

1. A method, comprising:
responsive to detection of a trigger event for a first host node monitored by at least a second host node, initiating fencing of the first host node by at least transferring a fencing notification to a controller module for a set of storage drives assigned to the first host node;
preventing the first host node from communicating with the set of storage drives by at least revoking a connection between the controller module and the first host node to block future connection requests with respect to the first host node; and
alerting a client node communicating with the first host node that the second host node is handling communication with the set of storage drives.

2. The method of claim 1, wherein the trigger event corresponds to one or more conditions being satisfied with regard to operational status of the first host node as monitored by at least the second host node.

3. The method of claim 2, wherein the operational status corresponds to periodic heartbeat signaling indicating the first host node is unresponsive.

4. The method of claim 1, wherein several redundant host nodes, including the second host node, monitor operation of the first host node and transfer associated fencing notifications to the controller module; and
wherein the second host node is selected by the controller module among the several redundant host nodes based at least on a prioritization scheme.

5. The method of claim 1, wherein transferring the fencing notification comprises transferring the fencing notification to the controller module though a redundant controller module in communication over a sideband communication link with the controller module.

6. The method of claim 1, wherein revoking the connection comprises at least revoking a remote direct memory access (RDMA) connection associated with the first host node to block connection requests from the first host node for the controller module.

7. The method of claim 1, wherein prior to the trigger event, the first host node handles storage transactions with respect to the client node; and
wherein subsequent to the trigger event, the second host node handles further storage transactions with respect to the client node.

8. The method of claim 1, comprising:
responsive to the trigger event, attempting to recover operation of the first host node while the first host node is fenced.

9. The method of claim 8, comprising:
responsive to the first host node recovering operational status, transferring a fencing removal notification to the controller module for the set of storage drives, wherein the controller module removes the fencing for the first host node with respect to the set of storage drives; and
alerting the client node communicating with the second host node that the first host node is handling communication with the set of storage drives.

10. The method of claim 1, wherein alerting the client node comprises transferring a notification for network addressing to reach the set of storage drives, wherein the network addressing corresponds to changing to a network address of the second host node.

11. The method of claim 1, wherein the first host node, the second host node, and the controller module are coupled over a communication fabric.

12. An apparatus, comprising:
one or more computer readable storage media; and
program instructions stored on the one or more computer readable storage media that, based on being executed by a processing system, direct the processing system to at least:
initiate fencing of a first host node by at least detection of a trigger event for the first host node monitored by at least a second host node and transferring a fencing notification to a controller module for a set of storage drives assigned to the first host node; and
responsive to the fencing notification:
prevent the first host node from communicating with the set of storage drives by at least revoking a connection between the controller module and the first host node to block future connection requests with respect to the first host node; and
alert a client node communicating with the first host node that the second host node is handling communication with the set of storage drives, wherein subsequent to the trigger event, the second host node handles further storage transactions with respect to the client node.

13. The apparatus of claim 12, wherein the trigger event corresponds to one or more conditions being satisfied with regard to operational status of the first host node as monitored by at least the second host node.

14. The apparatus of claim 12, wherein several redundant host nodes, including the second host node, monitor operation of the first host node and transfer associated fencing notifications to the controller module; and
wherein the second host node is selected by the controller module among the several redundant host nodes based at least on a prioritization scheme.

15. The apparatus of claim 12, comprising further program instructions that, based on being executed by the processing system, direct the processing system to at least:
transfer the fencing notification by at least transferring the fencing notification to the controller module though a redundant controller module in communication over a sideband communication link with the controller module.

16. The apparatus of claim 12, comprising further program instructions that, based on being executed by the processing system, direct the processing system to at least:
revoke the connection by at least revoking a remote direct memory access (RDMA) connection associated with the first host node to block connection requests from the first host node for the controller module.

17. The apparatus of claim 12, comprising further program instructions that, based on being executed by the processing system, direct the processing system to at least:
responsive to the trigger event, attempt to recover operation of the first host node while the first host node is fenced.

18. The apparatus of claim 17, comprising further program instructions that, based on being executed by the processing system, direct the processing system to at least:
responsive to the first host node recovering operational status, transfer a fencing removal notification to the controller module for the set of storage drives, wherein the controller module removes the fencing for the first host node with respect to the set of storage drives; and
alert the client node communicating with the second host node that the first host node is handling communication with the set of storage drives, wherein subsequent to the fencing removal notification, the first host node handles subsequent storage transactions with respect to the client node.

19. The apparatus of claim 18, comprising further program instructions that, based on being executed by the processing system, direct the processing system to at least:
alert the client node by at least transferring a notification for network addressing to reach the set of storage drives, wherein the network addressing corresponds to changing to a network address of the second host node.

20. A storage system, comprising:
a first host node, a second host node, and a storage input/output module coupled over a communication fabric;
the first host node configured to handle storage transactions for a client node with respect to an assigned set of storage drives managed by the storage input/output module;
the second host node configured to monitor the first host node for a failure event;
responsive to detection of the failure event for the first host node, the second host node configured to initiate fencing of the first host node by at least transferring a fencing notification to the storage input/output module;
the storage input/output module configured to prevent the first host node from communicating with the set of storage drives by at least revoking a connection between the controller module and the first host node to block future connection requests with respect to the first host node; and
the second host node configured to alert the client node that the second host node is handling subsequent storage transactions with the set of storage drives.
